(19) United States
(12) Patent Application Publication
(10) Pub. No.: US 2010/0043843 A1
(43) Pub. Date: Feb. 25, 2010

(54) CLEANING DEVICE

(76) Inventors: Maria Dröscher, Heidenheim (DE); Wolfgang Schneider, Stuttgart (DE); Karlheinz Straub, Heidenheim (DE)

Correspondence Address: TAYLOR & AUST, P.C., P.O. Box 560, 142. S Main Street, Avilla, IN, 46710, US

(21) Appl. No.: 12/561,565

(22) Filed: Sep. 17, 2009

Related U.S. Application Data
(63) Continuation of application No. PCT/EP2008/054084, filed on Apr. 4, 2008.

(30) Foreign Application Priority Data
Apr. 19, 2007 (DE) 10 2007 018 531.8
Apr. 19, 2007 (DE) 20 2007 005 670.2

(51) Int. Cl. B08B 13/00

(52) U.S. Cl. 134/95.3; 134/95.1

(57) ABSTRACT

An apparatus to clean a continuously running conveyor belt for a machine to produce or refine paper, cardboard or other layers of fibrous material including a cleaning device and at least one supplementary device. The cleaning device is configured to dispense at least one cleansing stream to the conveyor belt in at least one cleaning stage. The supplementary device is configured to dispense a chemically active medium and/or a physically active medium in a preparation process. The preparation process is configured to support and/or enhance the cleaning effectiveness and conditioning of a surface of the conveyor belt for a cleaning process.

### CROSS REFERENCE TO RELATED APPLICATIONS

This is a continuation of PCT application No. PCT/EP2008/054084, entitled “CLEANING APPARATUS”, filed Apr. 4, 2008, which is incorporated herein by reference.

### BACKGROUND OF THE INVENTION

1. Field of the Invention

The invention pertains to a device to cleanse a continuously cycling belt conveyor of a machine used for the production and/or refinement of paper, cardboard, or layers of fibrous material, containing a cleaning device to dispense at least one cleansing stream in at least one cleaning stage.

2. Description of the Related Art

It is already well known from production experience that high pressure devices can be used to clean drying sieves. The functional principle utilizes a highly pressurized stream of water, which impinges onto a sieve, thereby removing impurities. The water and the released impurities are then siphoned off.

Another possibility to fight sediment on drying sieves is to continuously spray cleansing or conditioning media onto the surface of the sieves. Conditioning media in use are, for example, silicon or certain cationic polymers. The application is facilitated by a spray pipe and singular fan nozzles or by at least one traversing and/or rotating nozzle. In each instance the entire width of the drying sieve is treated with the same intensity.

The WO-A2 2005-94403 document contains a description of a cleaning device to cleanse a belt conveyor between the compression process and the drying process. The cleaning is facilitated by traversing and/or rotating nozzles, which dispense, what is described as, a “shower of chemicals.”

The DE-A1 10 2004 022 954 document describes a process and an associated device to cleanse a circulating belt, in particular a drying sieve. The document discloses a combination of treatments, using at least one cleansing stream and at least one stream of a supplementary medium to achieve a chemical treatment. Both kinds of streams can be moved transversely to the direction of belt movement, preferably in a traversing fashion.

The chemical treatment described here, serves as a course of action to condition, passivate or impregnate the already cleaned surface of the belt conveyor. This is intended to prevent the renewed accumulation of new dirt.

This impregnation only works well when all contaminants or attachments have been completely removed from the entire belt, or sieve. To do this is oftentimes not possible with very tenaciously adhering contaminants.

What is needed in the art is a more effective device to cleanse these circling belt conveyors.

### SUMMARY OF THE INVENTION

According to the present invention, there is at least one supplementary device with at least one spray nozzle to dispense a medium in a preparation stage, which either supports the cleaning process or chemically conditions the surface for the cleaning process. Contaminants or adherents, such as ‘stickies’ or sediments of a coating medium for a layer of fibrous material that collect on the belt, are thereby softened, chemically attacked or etched, or dissolved.

The device of the present invention is therefore capable of removing even strong contaminants or other adhering material from the belt conveyor. Conditioning or impregnating is implemented on this machine, better than before and much more effectively.

It is also very useful when the preparation process, such as the application of chemically active media, is for the most part, but preferably entirely outside of the regime of the subsequent cleaning process. This arrangement avoids a condition in which the chemically active media is not applied at the same time as the water jets cleaning the belt, which would of course in doing so, wash the conditioning media away without allowing their intended effect to take place.

This is be supported by arranging the application of the supplementary device such that it is located before the cleaning device in the direction of movement of the belt conveyor as well as in the direction the cleaning medium is moving or the applicator itself. The preparation process is therefore relative to the cleaning direction before the cleaning stage.

The present invention sets sights for the cleaning device, which applies the cleansing stream, to have at least one static or rotating high pressure nozzle.

The supplementary device that applies the chemically active medium is shown with only a static nozzle that does neither move nor rotate. This device can contain a spray nozzle dispensing a single compound medium or media of two or even more compounds.

The chemically active medium used in the supplementary device can also have physical effects. The amounts of applied chemicals may vary across the affected area or across the preparation stage, to react to and target the actual distribution of contamination. In this context it is conceivable to employ specific chemicals, chemical compositions, concentrations or such. The media that provides a physical impact can also be employed, e.g. before or after, or simultaneously with the media that provides a chemical effect.

The aforementioned static nozzles can, by washing off the cleaning media, avoid or at least reduce their run-off into the environment.

It is also advantageous if the cleaning device and the supplementary device traverse across the belt width, such as transversely to its moving direction. This ensures that all areas of the belt conveyor are covered by chemically active media and/or physically active media and by at least one stream of a cleaning medium.

In some instances it may be advantageous if the supplementary device, dispensing media that provides either chemical or physical effects, traverses faster than the high pressure cleaning device, spraying the cleansing medium.

It is of further advantage if the supplementary device and the cleaning device are each assembled on a cross rail that spans the width of the belt conveyor. This provides a particularly stable and compact arrangement.

An alternative version consists of a spray pipe as a supplementary device, spanning the width of the belt conveyor and outfitted with a multitude of spray nozzles, dispensing chemically active media which consist of preferably two or more components. This allows the choice of controlling nozzles with varying intensity and aiming for the effective removal of contaminants. It is possible in this context, as earlier mentioned, to employ different chemicals.

As a medium for the cleansing stream it is sufficient to use water.

If so desired, it is also possible to incorporate a further supplementary device to dispense an impregnating medium, in particular a chemical impregnant. This additional supplementary device is intended to be placed upstream from the cleaning device in the direction of movement of the belt conveyor, or following the cleaning device in the direction of cleaning across the moving belt.

The device described by the present invention is suited to clean or, if so desired, to impregnate belt conveyors for machines used to produce paper or for machines used to refine paper. The term ‘belt’ also includes felts or sieves, in particular compression felts, drying sieves, belt conveyors or other supporting belts for a paper producing or paper refining machine.

Clean belts or sieves are better able to carry layers of fibrous material in a controlled fashion. Furthermore it is seen, that fewer tears occur during production in layers of fibrous material if belts are properly cleaned. The cost efficiency of the production and refining processes is thereby improved.

Subsequently, the invention is further explained on a specific instance of the invention.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a schematic depiction of the cleaning device proposed by an embodiment of the present invention in a side view; and

FIG. 2 is a schematic depiction of a top view of the device depicted in FIG. 1.

The figures depict objects, where corresponding components are marked with matching reference symbols.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

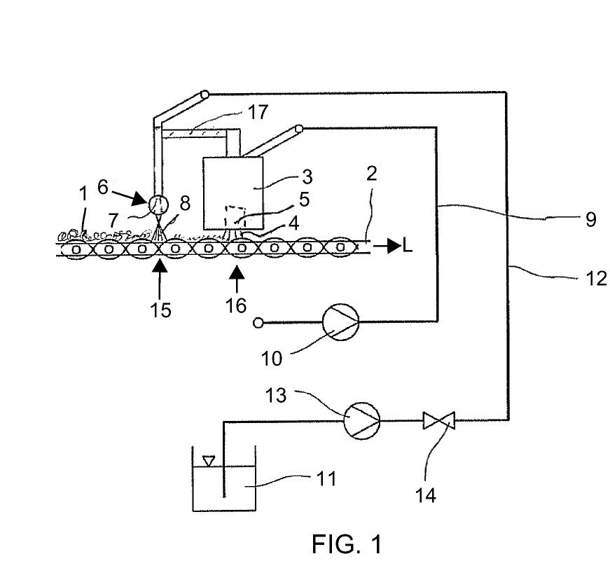

Referring now to the drawings, and more particularly to FIG. 1, there is shown a device for cleaning a continuously, in direction L running belt 1, that in this example is a drying sieve.

Contaminants 1 or adherents, such as ‘stickies’, that are to be removed from belt 2, are facing a cleaning device 3, which is intended to dispense at least one stream 4 onto the surface of belt 2. The illustrated example shows a high pressure nozzle 5 which is intended to dispense this cleansing stream 4. When facing a sieve or a compression stage, these nozzles would rotate.

Since even a high pressure nozzle 5 leaves something to be desired regarding cleaning efficiency, a supplementary device 6 is added. Supplementary device 6 includes at least one spray nozzle 7 to dispense a medium that either supports cleansing stream 3, or doles out a chemically active medium 8 that conditions the surface for the cleaning process. The contaminants are hereby chemically attacked and/or dissolved.

Supplementary device 6 or spray nozzle 7 to dispense the chemically active medium 8, respectively, are shown in the illustrated example as stationary, not capable of rotating, and may have two-component nozzles, that expel the chemically active medium 8 with compressed air.

The cleaning with cleaning device 3 and the conditioning with supplementary device 6, to prepare for the cleaning, occur in this example simultaneously, but separate from one another.

The high pressure cleansing nozzle 5 is connected to a supply line 9, through which water is supplied as a cleaning medium or cleansing stream 4 by way of a pump 10.

Spray nozzle 3 for dispensing the chemically active medium 8 receives the chemicals from a reservoir 11 through a separate supply line 12 which is fitted with a pump 13 and a valve 14.

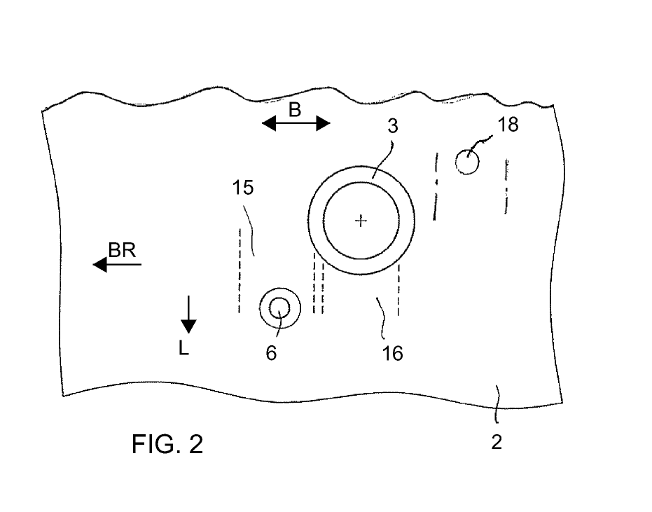

The depicted example in FIG. 1 also shows that the cleaning device and the supplementary device 6 are mounted on a common cross rail 17. Cross rail 17 allows their movement independent from one another, i.e. traversing across a width B of belt 2, transverse to the direction of movement L of conveyor belt 2 in a direction BR. This is further illustrated in FIG. 2.

In FIG. 2 it is clearly illustrated that supplementary device 6 is located as seen along the direction of movement L of conveyor belt 2, upstream, before cleaning device 3, and that there is a preceding preparation process 15 for the subsequent cleaning of cleaning process 16 (see also FIG. 1).

In order to prevent the chemically active medium 8 coming already in the preparation process 15 in contact with cleansing stream 4, preparation process 15 is kept outside of the range affected by the cleansing stream 4 in cleaning process 16.

In order to ensure this also while cleaning nozzle 4 and spray nozzle 7 are traversing, the preparation process 15 is, with respect to moving direction BR of nozzle or device 6 and 3, before cleaning process 16.

In order to prevent a recurring contamination of the belt 2 or to make such contamination less likely, another supplementary device 18 can be incorporated to administer a medium to condition, passivate or impregnate. This supplementary device 18 is located, looking in the direction of movement L of conveyor belt 2, upstream, i.e. before cleaning device 3, while looking in the direction of movement and cleaning BR, it is located downstream, i.e. after the cleaning device 3. Accordingly, the application of the impregnation medium occurs only after the conveyor belt 2 is completely cleaned, which makes the treatment all the more effective.

As can be seen in FIG. 2 the area in preparation process 15 becomes the area of cleaning process 12 as belt 2 makes one or more complete rotations. Further, this area then will become the area treated by supplementary device 18 after further rotations of belt 2. The speed of rotation of belt 2 is coordinated with the movement of rail 17 in direction BR.

In conclusion there is the possibility that instead of using chemically active media or in addition to the chemical media, one or several physically active media can be employed.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### List of Terms

1 contaminants, impurity, crud

2 belt conveyor

3 cleaning device

4 cleansing stream

5 high pressure nozzle

6 supplement device

7 spray nozzle

8 chemical substance or agent

9 feeding pipe, supply line

10 pump

11 storage tank, reservoir

12 supply line

13 pump

14 valve

15 preparatory phase

16 cleaning stage

17 cross rail, control arm

18 conditioner, treatment device

B width of belt conveyor

BR direction of movement

L moving direction

What is claimed is:

1. An apparatus to clean a continuously running conveyor belt for a machine that one of produces and refines one of paper, cardboard and other layers of fibrous material, the apparatus comprising:
a cleaning device configured to dispense at least one cleansing stream to the conveyor belt in at least one cleaning stage; and
at least one supplementary device configured to dispense one of a chemically active medium and a physically active medium in a preparation process, said preparation process being configured to one of support and enhance at least one of cleaning effectiveness and a conditioning of a surface of the conveyor belt for a cleaning process.

2. The apparatus of claim 1, wherein said preparation process includes applying at least one of chemically active media and physically active media to an area on the belt which is located at least partially outside of a range where the cleansing process takes place.

3. The apparatus of claim 2, wherein said area is entirely outside of the range where the cleansing process takes place.

4. The apparatus of claim 1, wherein said cleaning device includes at least one of a static high pressure nozzle and a rotating high pressure nozzle configured to apply the cleansing stream.

5. The apparatus of claim 1, wherein said supplementary device applies the chemically active medium, said supplementary device containing at least one of a static non-rotating single spray nozzle and a spray nozzle configured for dispensing two or more components.

6. The apparatus of claim 5, wherein said supplementary device is located upstream before the cleaning device when looking in a direction of movement of the conveyor belt, when looking in the direction of movement of the apparatus the nozzles are located upstream before the cleaning device, whereby the preparation process is located before the cleaning process.

7. The apparatus of claim 1, wherein the cleaning device and the supplementary device are configured to be operated separate from one another.

8. The apparatus of claim 1, wherein the cleaning device and the supplementary device are configured to be operated simultaneously.

9. The apparatus of claim 1, wherein the cleaning device and the supplementary device are configured to traverse across a width of the belt transverse to a direction of movement of the conveyor belt.

10. The apparatus of claim 9, wherein said supplementary device is a spray pipe that spans the width of the belt, said spray pipe being outfitted with a multitude of spray nozzles configured for dispensing chemically active media.

11. The apparatus of claim 9, wherein said supplementary device is configured to traverse faster than the cleaning device.

12. The apparatus of claim 9, further comprising a common cross rail which spans the width of the belt conveyor, wherein the supplementary device and the cleaning device are each mounted on said common cross rail.

13. The apparatus of claim 1, wherein the cleansing stream is highly pressurized water.

14. The apparatus of claim 1, further comprising an additional treatment device configured to dispense an impregnating medium, said impregnating medium being a chemically acting impregnating medium, said additional treatment device looking in the direction of movement of the conveyor belt is located upstream before the cleaning device, and said additional treatment device looking in the direction of movement of the nozzles is located downstream of the cleaning device.

15. The apparatus of claim 1, wherein the apparatus is configured to at least one of clean and condition the belt, the belt being one of a felt, a sieve, a compression felt and a drying sieve.
